(19) United States
(12) Patent Application Publication
(10) Pub. No.: US 2026/0089102 A1
(43) Pub. Date: Mar. 26, 2026

(54) TECHNOLOGIES FOR RADIO LINK CONTROL LAYER CONGESTION SIGNALING

(71) Applicant: Apple Inc., Cupertino, CA (US)

(72) Inventors: Ralf Rossbach, Munich (DE); Fangli Xu, Beijing (CN); Bobby Jose, San Diego, CA (US); Haijing Hu, Los Gatos, CA (US); Vijay Venkataraman, San Jose, CA (US); Ping-Heng Kuo, London (GB); Srinivas Reddy Mudireddy, San Diego, CA (US)

(73) Assignee: Apple Inc., Cupertino, CA (US)

(21) Appl. No.: 19/111,299

(22) PCT Filed: Sep. 29, 2022
(86) PCT No.: PCT/CN2022/122696

§ 371 Date: Mar. 12, 2025

(30) Foreign Application Priority Data
Sep. 23, 2022 (WO) PCT/CN2022/121039

(51) Int. Cl. H04L 47/11; H04L 69/322

(52) U.S. Cl. CPC H04L 47/11; H04L 69/322

(57) ABSTRACT

The present application relates to devices and components including apparatus, systems, and methods for congestion signaling by a radio link control layer in wireless networks.

### TECHNICAL FIELD

This application relates generally to communication networks and, in particular, to technologies for radio link control (RLC) congestion signaling in such networks.

### BACKGROUND

Low latency low loss scale throughput (L4S) is a technology based on an Internet Engineering Task Force (IETF) standardization. L4S provides high throughput and low latency for Internet protocol (IP) traffic that may result in improved, fast-radio adaption management and reduce network congestion, queuing, and packet loss.

### BRIEF DESCRIPTION OF THE DRAWINGS

FIG. 1 illustrates a network environment in accordance with some embodiments.

FIG. 2 illustrates the network environment with integrated access and backhaul concepts in accordance with some embodiments.

FIG. 3 illustrates a device in accordance with some embodiments.

FIG. 4 illustrates RLC control protocol data unit (PDU) formats in accordance with some embodiments.

FIG. 5 illustrates RLC acknowledged mode data (AMD) PDU formats in accordance with some embodiments.

FIG. 6 illustrates RLC unacknowledged mode data (AMD) PDU formats in accordance with some embodiments.

FIG. 7 illustrates an operation flow/algorithmic structure in accordance with some embodiments.

FIG. 8 illustrates an operation flow/algorithmic structure in accordance with some embodiments.

FIG. 9 illustrates an user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

Current L4S technology relies on an explicit congestion notification (ECN) in an IP header to indicate queue buildup in intermediate routers or radio links. Upon ECN reception, congestion signals may be propagated back to a sender. The signals may be sent via a transmission control protocol (TCP) ECN-echo that trigger scalable congestion control algorithms. A TCP congestion window reduced (CWR) bit may be sent back to acknowledge to the receiver that the congestion-indication echoing was received. Similar signaling may be supported on other layer 4 (L4) protocols such as QUIC.

When congestion is detected, the application server or the application may adjust the application bit rate to meet capacity of the established communication link. As a result, L4S may deliver a seamless user experience even with variable traffic load and radio conditions.

Changing the ECN bits in an IP header as a queue starts to grow to signal congestion may be referred to as marking. ECN/L4S use to least significant bits of a traffic class field in an IPV4 or IPv6 header to encode four different code points. In ECN, a congestion mark is equivalent to a packet drop. In L4S, they congestion mark serves as an indication instead of dropping the packet.

L4S allows relatively fine granular congestion control depending on the application (for example, with active queue management (AQM) and scalable TCP). L4S allows for improved queue utilization and better use of network resources. If applied to the radio, it may allow for better spectrum utilization. Routers or nodes using AQM may signal EC and immediately upon detecting high delay or high buffer status.

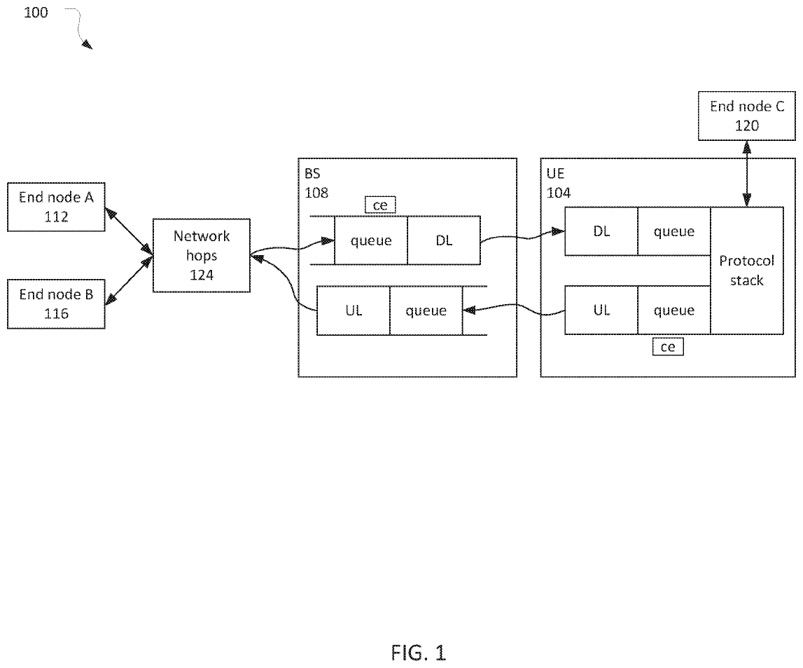

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The network environment 100 further includes three end nodes, end node A 112, end node B 116, and end node C 120. While shown separately in FIG. 1, end node C 120 may also be part of UE 104.

The end nodes may communicate with one another through the UE 104, base station 108, and one or more network hops 124. The end nodes may host application layers that communicate application traffic with one another over the intervening network nodes. The network hops 124 may include hops in a RAN, core network (CN), external data network, etc.

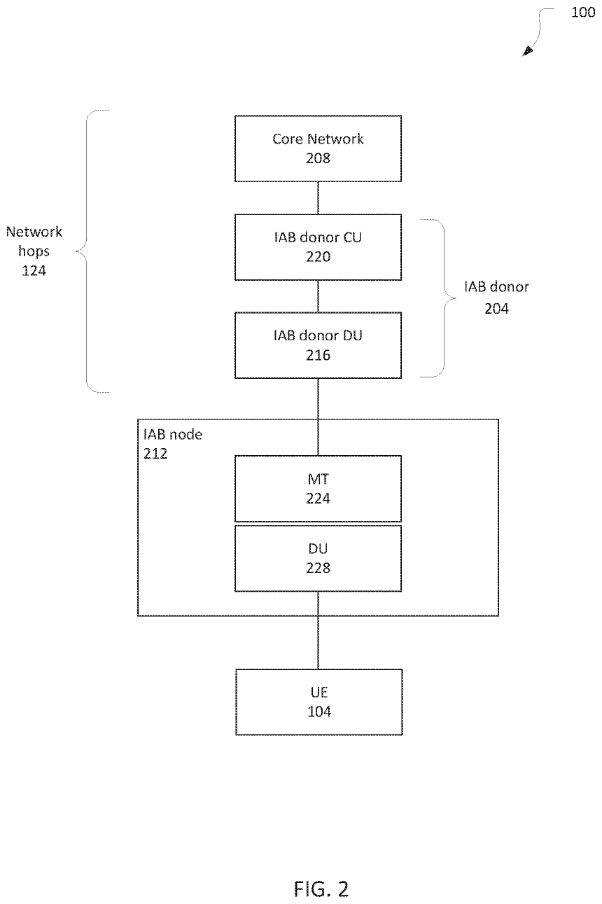

In some embodiments, the BS 108 or devices of the network hops 124 may include integrated access and backhaul (IAB) nodes that facilitate relaying of access traffic by sharing radio resources between access and backhaul links. FIG. 2 illustrates the network environment 100 implementing IAB concepts that may be used in some embodiments. In an IAB deployment, the network hops 124 may include an IAB donor 204 and core network 208. The IAB donor 204 may be a RAN node that provides an interface to the core network 208 and provides wireless backhauling functionality to an IAB node. An IAB node is a RAN node that provides the UE 104 with wireless access and wirelessly backhauls the access traffic to another IAB node or an IAB donor.

The base station 108 may correspond to a gNB or one or more of the IAB nodes (for example, IAB node 212, IAB donor 204, etc.). In some embodiments, the base station 108 may be separate from the IAB nodes and may be provided, for example, between IAB node 212 and the UE 104. The network hops 124 may include additional IAB nodes between IAB node 212 and the IAB donor 204.

The IAB donor 204 may have a distributed unit (DU) 216 and a centralized unit (CU) 220 disposed on separate devices. In general, the IAB donor CU 220 may handle higher-layer protocols, for example, radio resource control (RRC), packet data convergence (PDCP), and service data adaptation protocol (SDAP) layer protocols, while the IAB donor DU 216 may handle lower-layer protocols, for example, radio link control (RLC), media access control (MAC), and physical (PHY) layer protocols. In some embodiments, the base station 108 may provide CU and DU entities (for example, gNB-CU and gNB-DU).

The IAB node 212 may include a mobile termination (MT) 224 and a DU 228 that is coupled with the UE 104 or another IAB node. The MT 224 may be used to connect the IAB node 212 with an upstream (for example, towards the core network 208) RAN node (for example, IAB donor DU 216). In general, the MT 224 may provide the IAB node 212 with access functionality similar to a UE. For example, the MT 224 may utilize protocols that a typical UE may use to connect to a RAN. The MT 224 may, for example, allow the IAB node 212 to establish signaling radio bearers (SRBs) and/or data radio bearers (DRBs) with a parent node. The MT 224 may perform cell selection to identify an upstream RAN node to join and then set up and utilize an RLC channel through a backhaul adaptation (BAP) layer that provides functionality for routing data for different UE bearers over different routes through the network. The MT 224 may also perform, for example, cell reselection, radio-link failure, etc. In some embodiments, the IAB node to which the MT 224 connects, for example, the IAB donor 204, as shown, or another IAB node, may be considered the base station 108.

In a cellular data path architecture included within the network environment 100, queuing may apply to packets in the UE 104 and the BS 108. With respect to the UE 104, to ensure layer 2 (L2)/MAC has sufficient data available, new data from upper layers may constantly be added to the local queue. Based on anticipation of uplink grants from the BS 108, the data path may encipher and have new packets ready to be transmitted. However, due to the highly dynamic nature of wireless links in cellular networks such as 5G network at millimeter wave (mmWave) frequencies, it may be possible that throughput may drop for a sustained period of time. This may happen when the UE 104 has a non-line-of-sight (NLOS) connection with the frequency range 2 (FR2) tower. Additionally, due to sub-optimal radio conditions, the wireless link may experience retransmission of packets at several layers such as, for example, a MAC layer or a radio link control (RLC) layer. In such cases, the L2/MAC queues may experience buffer bloat. Similarly, with respect to the BS 108, packets may be queued up and waiting for scheduling opportunity and, based on the bandwidth conditions, the queues may experience buffer bloat. Embodiments of the present disclosure provide for detecting congestion at the queues of, for example, the UE 104 and BS 108. Upon detection of a congestion event, embodiments provide for setting a congestion experienced (CE) indication, which may be used to assist an application at one of the end nodes. The CE indication may be provided via ECN/L4S fields in an IP header and elsewhere as described herein.

5G NR and LTE support ECN at the IP layer where a base station and UE may insert ECN code points as specified in clause 5 of IETF request for comments (RFC) 3168, “The Addition of Explicit Congestion Notification (ECN) to IP,” September 2001. In particular, a UE and a base station may set a CE codepoint ‘11’ in a packet data convergence protocol (PDCP) service data unit (SDU) (in the IP packet). However, this means that ECN marking can only happen at the tail of the queue. Given that a UE's L2 buffer can be very large and grant-scheduling delays may exist, an ECN/L4S marking at an end of the queue may come with the disadvantage of additional delay for the CE endpoint reaching its destination. Embodiments described herein provide insertion of a CE codepoint at a head of an RLC queue, for example, for transmission over an air interface.

The support of extended reality (XR) services require low latency and high throughput. L4S may be used to reduce latency and congestion and insured desired experience for users of XR services.

ECN/L4S is an end-to-end mechanism that depends on the capability of the transport network. It may enable faster codec rate adaptation at end points and may help to keep latency low and throughput high.

From a radio interface perspective, it may be advantageous to determine whether or not congestion exists at radio layers or other points within a 5G system. In some embodiments, congestion at an air interface may be indicated using one CE bit that is communicated to upper sublayers and translated into respective representation at an IP layer. However, to allow supportive use cases in which full end-to-end ECN/L4S consistency is desired, some embodiments may provide the CE indication with more than one bit (for example, two bits). ECN, L4S, and CE may be used interchangeably throughout this description.

Embodiments describe how an RLC layer can support an early CE indication mechanism that allows insertion of indication packets at a head of a queue. Embodiments include providing a CE indication at layer 2 over RLC. Some aspects include inclusion of CE codepoints over an RLC entity, RLC control/data PDU header formats, methods to signal CE indications early on, and aspects to populate CE information to upper layers.

Some embodiments provide for CE indication at the RLC layer as follows.

As mentioned earlier, 5G NR currently relies on ECN marking starting from the tail of the PDCP queue (i.e., from the head of the IP queue), which is slow considering the large size of the L2 buffer. One the other hand, XR services require lower latency and high throughput. To insert ECN/CE markings at the head of a normal PDCP DRB is rather difficult because PDCP performs ciphering and integrity protection. Hence, PDUs at the head of the PDCP queue cannot easily be modified by inserting ECN/CE marks directly.

Some embodiments provide for insertion of CE indications at the head of an RLC queue for an RLC entity in a new RLC header field. This may be enabled, in part, given that RLC headers are not ciphered.

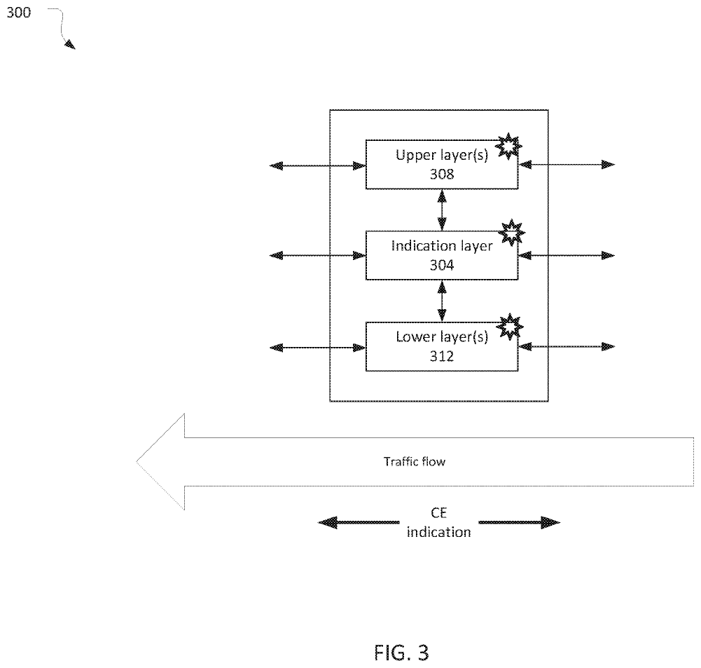

FIG. 3 shows a device 300 in accordance with some embodiments. The device 300 may be the UE 104, base station 108 (as an IAB node or distinct therefrom), or a device of the network hops 124 (for example, an IAB node/donor). The device 300 may include a number of protocol layers, shown generically as indication layer 304, upper layer(s) 308, and lower layer(s) 312. The indication layer 304 may be an RLC layer that provides an indication of the congestion event. The upper layer(s) 308 and lower layer(s) 312 may be defined with respect to the indication layer 304.

In various embodiments, the congestion event may be detected at the indication layer 304, the upper layer(s) 308, or the lower layer(s) 312. If the congestion event is detected in the upper layer(s) 308 or the lower layer(s) 312, the detection layer may inform the indication layer 304 with a congestion indication or event, for example, in a primitive or a message.

Upon detecting the congestion event, either directly or from inter-layer signaling, the indication layer 304 may initiate generation of RLC packets that include CE indications, which may be referred to as CE packets. These CE packets may be transmitted from the indication layer 304 in the same direction as the traffic flow in which the congestion was detected, or in the opposite direction.

While embodiments describe the indication layer 304 providing CE indications in RLC packets transmitted in the uplink or downlink, it may be noted that the indication layer 304 may also inform upper layer(s) 308 or lower layer(s) 312 of the congestion. For example, if the indication layer 304 detects the congestion, or receives an indication of such from lower layer(s) 312, it may generate/send the CE packets and may also provide the upper layer(s) 308 with a congestion indication. For another example, if the indication layer 304 detects the congestion, or receives an indication of such from upper layer(s) 308, it may generate/send the CE packets and may also provide the lower layer(s) 312 with a congestion indication.

An RLC layer of a device may transfer upper layer PDUs in an acknowledged mode (AM), unacknowledged mode (UM), or transparent mode (TM). The RLC layer may manage RLC service data units (SDUs) and PDUs separately for each of these modes to provide error detection and recovery. The RLC may provide error correction through automatic repeat request (ARQ) for AM data transfers and may perform concatenation, segmentation, and reassembly of RLC SDUs for both UM and AM data transfers. The RLC may also provide a variety of other operations including, for example, executing re-segmentation of RLC data PDUs for AM data transfers, reordering RLC data PDUs for UM and AM data transfers, detecting duplicate data for UM and AM data transfers, discarding RLC SDUs for UM and AM data transfers, detecting protocol errors for AM data transfers, and performing RLC re-establishment.

An AM RLC may use state variables to assist in its functions on the transmitting side. These state variables may include: a send-state variable that has a sequence number (SN) to be assigned for the next AMD PDU that is to be generated; an acknowledgment state variable with an SN of the next RLC SDU for which a positive acknowledgement is to be received in sequence; and a poll-send state variable that has a highest SN of AMD PDUs submitted to lower layers with the variable is set.

With respect to RLC state variables, insertion of a complete RLC data PDU on the fly, e.g., at the head of the queue may be complex as it may involve updating the RLC state variables. Embodiments of the present disclosure may provide for RLC congestion signaling in a manner that avoids complications with respect to the RLC state variables. For example, embodiments may utilize unused bits in the RLC header of an RLC Data PDU or add new header fields for the purpose of CE indication. Those header fields can be updated on the fly shortly before transmission.

With respect to RLC segmentation, the CE indication may only need to be inserted in the first segment or the last segment. Alternatively, the CE indication could be included in any segment (or all segments), to increase reliability and to allow faster processing without waiting for remaining segments.

In some instances, PDCP duplication may be used in which one PDCP entity is associated with a plurality of RLC entities. If PDCP duplication is enabled in embodiments, consideration may be taken to select the appropriate RLC entity and reduce sending the same CE indication at other RLC entities. For example, with PDCP duplication, a late update of the RLC header may quickly become complex if it is to be done across four RLC entities. Likewise, if a DRB is configured as a split-bearer, the CE indication may go on any RLC entity, likely selecting the RLC entity having the smallest delay.

In some embodiments in which a plurality of RLC entities exist, a primary RLC entity may be selected to signal the CE indication. However, in other embodiments other RLC entities may be selected.

In some embodiments, RLC CE indication operations may only need to be performed if an IP flow or a DRB supports ECN/L4S. To achieve this, RLC may be configured by RRC to enable/disable ECN/L4S (CE) indication. For example, in some embodiments, the RLC layer may ensure that the CE indication is enabled for an IP flow or DRB before signaling a CE indication. Additionally/alternatively, upper layers may check the content of the IP header (for example, the ECN bits for every packet). The upper layers may provide an indication to the RLC of whether the IP flow or DRB supports ECN/L4S. If supported, the RLC may perform CE indication operations.

As will be discussed in further details herein, an RLC transmitter may add CE indications in an RLC header of an RLC Control PDU or an RLC data PDU. The CE indications may be supported for both RLC UM and RLC AM.

In some embodiments, an RLC transmitter may be allowed to update an RLC header field of a plurality of RLC PDUs with the same content. This may be used to increase reliability of the CE indication information in case the RLC PDU gets lost over the air. Additionally/alternatively, this may be used to relax constraints on device implementation at, for example, the UE 104, the IAB-MT 224, or the BS 108), as these devices may mark CE packets in an asynchronous manner.

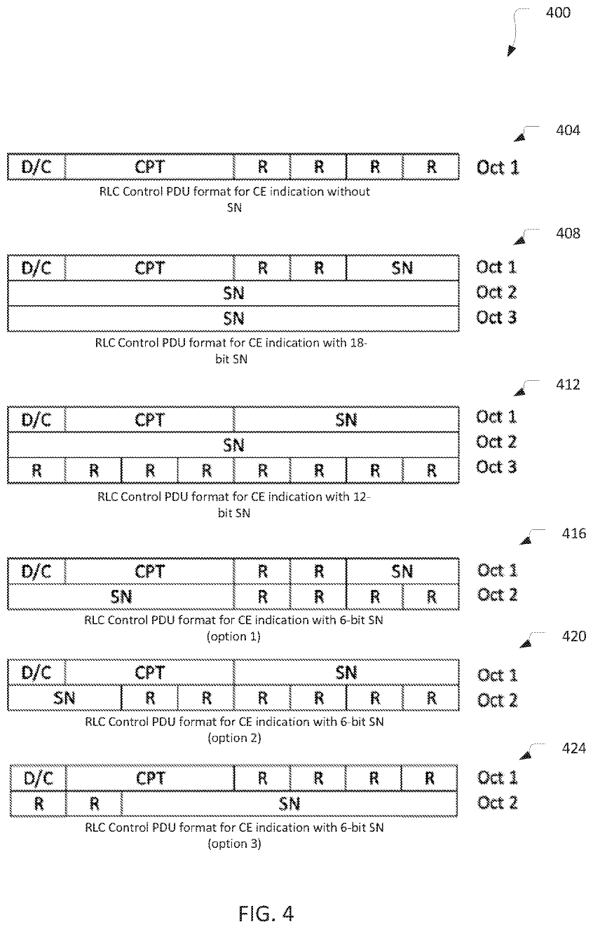

FIG. 4 illustrates RLC control PDU formats 400 for CE indications in accordance with some embodiments. In particular, the formats 400 may include a format 404 that is an RLC control PDU format for CE indication without SN; format 408 that is an RLC control PDU format for CE indication with 18-bit SN; and format 412 that is an RLC control PDU format for CE indication with 12-bit SN. The formats 400 may further include formats 416, 420, and 424, which represent three options for RLC control PDU formats for CE indication with 6-bit SN. Format 416 corresponds to a first option in which two reserved bits, marked as “R,” are situated in the first octet and the SN is distributed among the first and second octets. Format 420 corresponds to a second option in which all reserved bits are in the second octet and the SN is distributed among the first and second octets. Format 424 corresponds to a third option in which four reserved bits are in the first octet and the SN is in the second octet. The RLC entity may use one or two bits of the reserved bits to provide the CE indication.

The transmitter may insert one or more RLC control PDUs based on any of these formats to indicate a congestion status for an RLC entity. The control PDU may be inserted at head of the RLC queue (first position), or its transmission may be prioritized over other PDUs in the queue.

If one bit is used to provide the CE indication in the RLC control PDU format, the CE indication may be a CE-set indication or a CE-clear indication. The CE-set indication may indicate the traffic flow is experiencing congestion. The CE-clear indication may indicate the traffic flow is not experiencing congestion. While many embodiments describe congestion as existing in a binary state, for example, either congestion is present or is not, other embodiments may provide for different levels of congestion being detected/signaled in similar matters.

If two bits are used to provide the CE indication, they may correspond to codepoints according to ECN codepoints shown in Table 1 or LAS codepoints shown in Table 2 below.

TABLE 1

| Binary codepoint | Codepoint name | Meaning |
|---|---|---|
| 00 | Not-ECT | Not ECN-capable transport |
| 01 | ECT(1) | ECN-capable transport |
| 10 | ECT(0) | ECN-capable transport |
| 11 | CE | Congestion experienced |

TABLE 2

| Binary codepoint | Codepoint name | Meaning |
|---|---|---|
| 00 | Not-ECT | Not ECN-capable transport |
| 01 | ECT(1) | L4S-capable transport |
| 10 | ECT(0) | Not L4S capable transport |
| 11 | CE | Congestion experienced |

These codepoints may be similar to those described in IETF RFC 3168.

In some embodiments, upon reception of an RLC control PDU with a CE indication and no SN, the receiver may associate the congestion indication with the first SN currently in the queue. This may be, for example, the next SN delivered to upper layers.

In some embodiments, upon reception of an RLC control PDU with a CE indication and an SN, the receiver may associate the congestion indication with the indicated SN. The receiver may also associate the congestion indication onwards for all following SNs until receiving a different congestion indication.

As briefly discussed above, for a PDCP entity associated with a plurality of RLC entities, the CE indication may be sent on one or more RLC entities. One of a plurality of RLC entities associated with a PDCP entity may be selected to provide the CE indication. The one entity may be the primary RLC entity, a network-configured RLC entity, or any other RLC entity that may be, for example, selected by device implementation or based on queue size/status. In some embodiments, more than one RLC entity may be used to provide the CE indication including, for example, all RLC entities.

Table 3, below, illustrates codepoint values for a control PDU type (CPT) field that may be set in one of the formats 400 in accordance with some embodiments.

TABLE 3

| Value | Description |
|---|---|
| 000 | STATUS PDU |
| 001 | CE PDU with no SN |
| 010 | CE PDU with 18-bit SN |
| 011 | CE PDU with 12-bit SN |
| 100 | CE PDU with 6-bit SN |
| 101- | Reserved |
| | (PDUs with this coding will be discarded |
| | by the receiving entity for this |
| | release of the protocol) |

A CPT field may be a 3-bit field that indicates a type of the RLC control PDU.

Some embodiments may provide the CE indication via RLC data PDUs. These PDUs may be RLC AM data (AMD) PDUs or RLC UM data (UMD) PDUs. A PDU header may include a segment offset (SO) field only when the data field consists of an RLC SDU segment that is not the first segment. Therefore, if a CE indication is only included in a first segment, then only the UMD/AMD PDU formats without SO field need to be considered. Otherwise, the remaining RLC PDU formats need to be updated in a similar way.

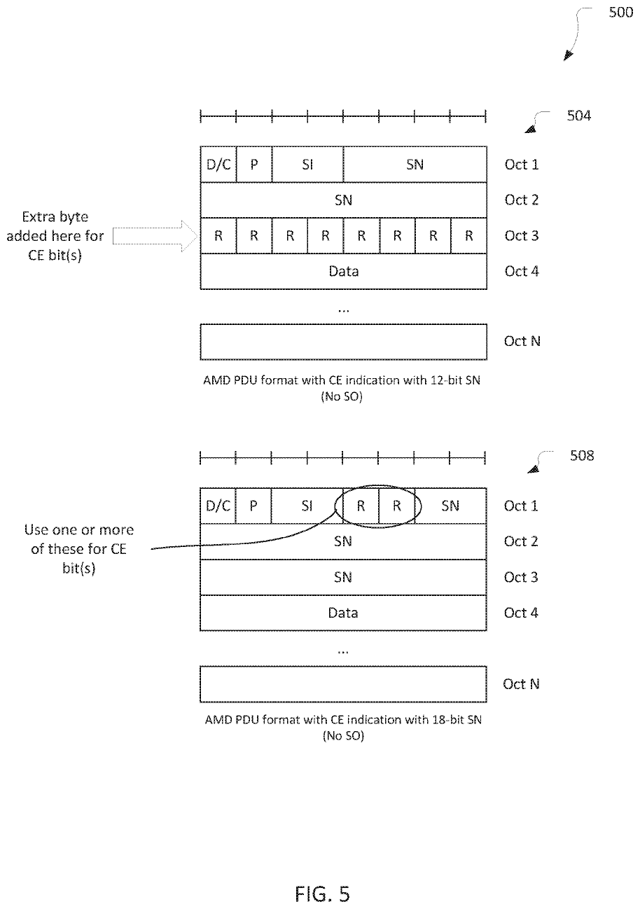

FIG. 5 illustrates RLC AMD PDUs 500 in accordance with some embodiments. In particular, FIG. 5 illustrates format 504 and format 508.

Format 504 is an AMD PDU format with CE indication with 12-bit SN and no SO. Legacy AMD PDU format with 12-bit SN and no SO may not have reserved bits available. Thus, in format 504, one extra byte is added after the second octet so that one or more of the reserved bits may be used for the CE bit(s) used for the CE indication.

Format 508 is an AMD PDU format for CE indication with 18-bit SN and no SO. Format 508 includes two reserved bits in the first octet. One or more of these bits may be used as CE bit(s) for the CE indication.

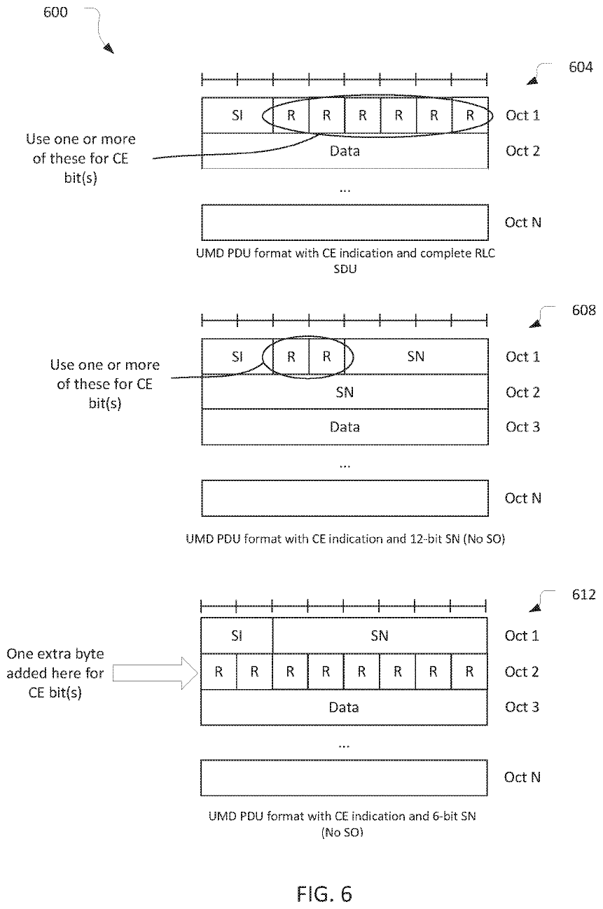

FIG. 6 illustrates RLC UMD PDUs 600 in accordance with some embodiments. In particular, FIG. 6 illustrates format 604, format 608, and format 612.

Format 604 is a UMD PDU format with CE indication with 12-bit SN and a complete RLC SDU. Format 604 includes six reserved bits in the first octet. One or more of these bits may be used as CE bit(s) for the CE indication.

Format 608 is a UMD PDU format with CE indication with 12-bit SN and no SO. Format 608 includes two reserved bits in the first octet. One or more of these bits may be used as CE bit(s) for the CE indication.

Format 612 is a UMD PDU format with CE indication with 6-bit SN and no SO. Legacy UMD PDU format with 6-bit SN and no SO may not have reserved bits available. Thus, in format 612, one extra byte is added in the second octet so that one or more of the reserved bits may be used for the CE bit(s) used for the CE indication.

Assuming that CE indications are only used on DRBs mapped to IP flows that support ECN/L4S, only one CE bit may be needed to set or clear the congestion indication. The use of the congestion indications for an RLC entity may be enabled/disabled based on RRC configuration.

When the receiving side of an RLC entity receives a PDU with a congestion indication, and if the same PDU has been received multiple times (e.g., in duplication), it may consider the congestion marking on only one RLC entity. However, duplicated PDUs are discarded by the RLC receiver for RLC AM in any event.

Operations performed by an RLC entity that receives a PDU with a congestion indication may be described as follows for some embodiments.

Upon reception of an RLC PDU with a CE indication, an RLC receiver may perform one or more of the following options.

In a first option, if an RLC header contains a CE marking that indicates congestion is being experienced by the traffic flow (for example, one CE bit is set to ‘l’ or two CE bits are set to ‘11’), the RLC receiver may deliver the congestion marking to upper layers (e.g., a PDCP layer or a backhaul adaptation protocol (BAP) layer). The RLC layer may provide an upper layer with the congestion indication in a primitive, event, or message designed for inter-layer signaling. This inter-layer signaling may apply to this and other options/embodiments described herein

In a second option, if the RLC header contains a CE indication that indicates congestion is not experienced by the traffic flow (for example, one CE bit is set to ‘0’ or two CE bits are set to ‘00,’ ‘01,’ or ‘10’) but the last CE indication indicated congestion was experienced, the RLC receiver may deliver the congestion marking to upper layers (e.g., a PDCP layer or a BAP layer).

In a third option, the RLC receiver may transparently forward the content of the CE bits to upper layers (e.g., PDCP or BAP) for every PDU.

In a fourth option, the RLC receiver may forward the content of the CE bits to upper layers (e.g., PDCP or BAP) only if the content has changed compared to the previous PDU.

These options may involve the RLC receiver checking the CE bit(s) on every RLC Data PDU. However, in some embodiments, an RLC Control PDU with a CE indication may only be sent if the congestion status has changed in order to reduce overhead.

When two CE bits are supported, the RLC entity may check/deliver the indication information to upper layers only if ECN/L4S is indicated as enabled by the transport layer (e.g., ECN/L4S capable transport).

Sequence numbering aspects may be handled at the receiver in accordance with one or more of the following options.

In a first option, the RLC receiver may indicate a congestion indication to upper layers (e.g., the PDCP layer or the BAP layer) from the earliest possible SN onwards. The congestion indication may be valid for all SNs that follow until a new congestion indication associated with a different congestion condition is received, in which case the new congestion indication may be sent to upper layers. For example, if the RLC receiver receives a CE-set indication associated with SN 15. It may provide a congestion indication to the upper layers to indicate SN 15 is experiencing congestion. It may be assumed that all SNs after SN 15 also experience congestion. If the RLC receiver receives a CE-clear indication associated with SN 23, it may provide a different congestion indication to the upper layers to indicate that SN 23 is not experiencing congestion.

In a second option, the RLC receiver may provide a congestion indication to upper layers (e.g., the PDCP layer or the BAP layer) from the next SN that is delivered. For example, if a CE indication is received with SN 15 or after SN 15, the RLC receiver may provide a congestion indication to the upper layer for SN 16 if that is the next SN eligible to be delivered to the upper layer. The indication may be valid for all SNs that follow until the congestion condition is changed, in which case another indication may be sent to upper layers.

In a third option, the RLC receiver may provide a congestion indication to upper layers (e.g., the PDCP layer or the BAP layer) from the optional SN indicated in the RLC PDU onwards. The optional SN may correspond to an SN provided to indicate a place in a queue to which a CE indication is to apply, or a second SN in an RLC data PDU. The indication may be valid for all SNs that follow until the congestion condition changes, in which case another indication may be sent to the upper layers.

In a fourth option, the RLC receiver may forward the content of the CE bits to upper layers (e.g., the PDCP layer or the BAP layer) for every PDU. The RLC receiver may not need to keep track of the existing congestion condition in this situation, as the indications may be transparently forwarded.

In a fifth option, the RLC receiver may forward the content of the CE bits to upper layers for any PDU in which the CE indication indicates congestion is being experienced (for example, on CE bit is set to ‘l’ or two CE bits are set to ‘11’).

In a sixth option, the RLC receiver may provide a congestion indication to the upper layers (e.g., the PDCP layer or the BAP layer) only for a specific SN. For example, if the RLC layer receives a CE-set indication for SN 15, it may provide one congestion indication to the upper layers for SN 15 and not for subsequent SNs.

An RLC transmitter may operate as follows in accordance with some embodiments.

When using a one-bit CE indication, the transmitter may set the CE bit to indicate a CE-set condition (for example, set the CE bit to ‘1’) when congestion is detected (for example, the traffic flow is experiencing congestion). The RLC transmitter may set the CE bit to indicate a CE-clear condition (for example, set the CE bit to ‘0’) when congestion is not detected (for example, the traffic flow is not experiencing congestion). The CE-clear condition may correspond to the default value.

When two CE bits are supported, the RLC transmitter may provide the CE indication only if ECN/L4S is indicated as enabled by the transport layer (e.g., the device has an ECN/L4S-capable transport). The CE bits may be set to ‘11’ to indicate that congestion is experienced by the traffic flow, and may be set to a default value of the connection when no congestion is detected. The default value of the connection can be configured by upper layers or may be detected based on the content of the IP header for a PDU (e.g., from the IP payload), which may be signaled to the RLC layer from upper layers.

In another aspects, the RLC transmitter operations may mirror the same type of operations as indicated at the RLC receiver, but for the opposite direction.

Upon detecting the presence or absence of congestion, the RLC transmitter may set the CE bit(s) in an RLC PDU according to one or more of the following options.

In a first option, if congestion was detected in RLC or if other layers indicate congestion is present, the RLC transmitter may set or update the CE marking to provide a CE-set indication (for example, one-bit CE set to ‘1’ or two-bit CE set to ‘11’) in the RLC header.

In a second option, if congestion was not detected in RLC or if other layers indicate that congestion is not present, the RLC transmitter may set the CE marking to provide a CL-clear indication (for example, one-bit CE set to ‘1’ or two-bit CE set to ‘00,’ ‘01,’ or ‘10’) in the RLC header.

In a third option, the RLC transmitter may transparently mirror the content of CE bits received from other layers in the RLC header for every PDU. For example, the RLC transmitter may receive inter-layer signaling of a congestion indication and may set the CE bits in the RLC header based on the congestion indication.

In a fourth option, the RLC transmitter may update the content of the CE bits in the RLC header only if the content has changed compared to the previous PDU.

These options may include the RLC transmitter checking whether ECN/L4S or CE bit(s) is supported by the traffic flow. In some embodiments, an RLC Control PDU with CE indication may be sent only if the congestion status has changed in order to reduce overhead.

In some embodiments, when two CE bits are supported, the RLC entity may insert the two CE bits in an RLC header only if ECN/L4S is indicated as enabled by the transport layer. For example, only if the device has an ECN/L4S-capable transport.

Sequence numbering aspects may be handled at the RLC transmitter in accordance with one or more of the following options.

In a first option, the RLC transmitter may provide a CE indication in the RLC header from the earliest possible SN onwards. The CE indication may be valid for all SNs that follow (and included in respective RLC headers) until the underlying congestion condition changes, in which case the CE indications within the RLC headers may be changed as appropriate.

In a second option, the transmitter may provide a CE indication in the RLC header from the next SN that is delivered. The indication may be valid for all SNs that follow (and included in respective RLC headers) until the underlying congestion condition changes, in which case the CE indications within the RLC headers may be changed as appropriate.

In a third option, the transmitter may indicate a congestion experienced indication in the RLC Control PDU header along with its optional SN. The indication may be valid for all SNs that follow (and included in respective RLC headers) until the underlying congestion condition changes, in which case the CE indications within the RLC headers may be changed as appropriate.

In a fourth option, the RLC transmitter may insert the contents of the CE bits received from upper layers in the RLC header every time. In this embodiment, the RLC transmitter may transparently update the RLC headers based on congestion indications provided to the RLC layer from other layers.

In a fifth option, the transmitter may provide a congestion indication in an RLC header for a specific SN only. For example, if congestion is detected with respect to SN 15, the RLC transmitter may provide set CE bits in an RLC header associated with SN 15 in a manner to indicate the congestion. RLC headers associated with following SNs may not be set based on the detected congestion.

In some embodiments, a congestion condition may be indirectly updated based on RLC status reporting.

Setting a congestion indication in RLC using the RLC status report may be performed as follows. One of the R bits of the RLC status report can be used for a CE bit to indicate a CE-set condition or a CE-cleared condition. The first SN to which the congestion indication applies may be identified from ACK_SN/NACK SN (whatever is lower). This method may work in the direction from the receiver to the transmitter. For example, upon detecting a congestion event, the base station 108 (DU or CU) may send the RLC status report, with CE indication, in the downlink to the UE 104. The base station 108 may also insert the CE bits in the forward direction towards UPF. An RLC receiver at the UE 104 may provide a congestion indication to its IP layer (from the indicated SN onwards or immediately) for signaling L4S in the uplink. Further, in some instances, a CE indication provided in the RLC Status Report can serve as a hint to the UE's lower layers to schedule fewer data on that RLC queue in situations in which there is a choice to do so.

Network layer impact may be described as follows in accordance with some embodiments.

Since RLC may only be supported between UE (or IAB-MT) and gNB-DU, the IAB node or the base station 108 may extract the CE information from the RLC header and deliver it to upper layers, forward it to the next hop, use flow control mechanisms (available on RAN3 interfaces) to signal congestion, or forward L4S feedback to upper layers which forward the feedback indication further (e.g., at the gNB-CU). Forwarding CE indications to upper layers may be performed by: forwarding over GTP to the UPF, which then updates the IP header; the BS 108 updating the IP header in the PDCP SDU; or the BS 108 forwarding the LAS information to/from the IP layer. A final destination of the CE indication may be the application layer. Thus, the UPF may need to forward/apply the CE indications further.

The same process may also apply in the opposite direction.

Advantages of RLC-based CE indications may include finer granularity in terms of SNs, since very late updates (shortly before delivery to MAC) are possible. Thus, CE indications become very fast. Further, the options with RLC Control PDUs may be less complex. However, some implementation complexity may need to be addressed and other network entities may require piggy-backing of L4S information.

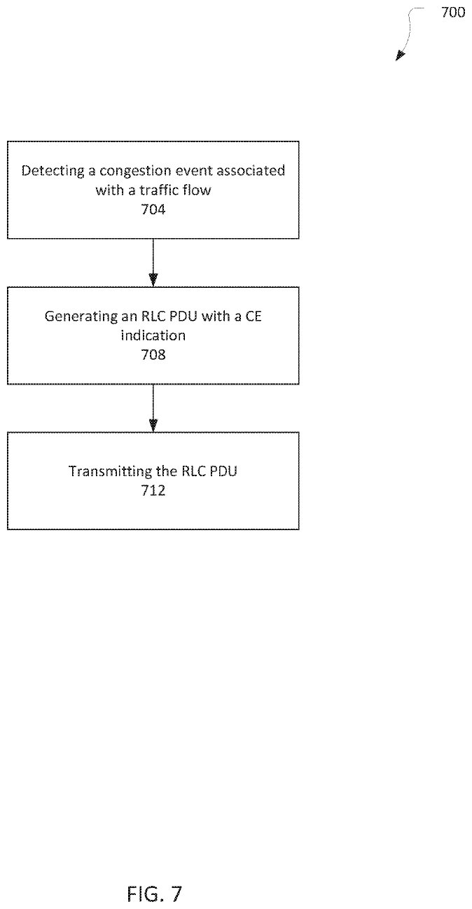

FIG. 7 is an operation flow/algorithmic structure 700 in accordance with some embodiments. The operation flow/algorithmic structure 700 may be implemented by an RLC transmitter included in a UE (for example, UE 104 or UE 900), or a network node (for example, BS 108, IAB node 212, IAB donor 204, or network node 1000) or components therein, for example, processing circuitry 904 or 1004.

The operation flow/algorithmic structure 700 may include, at 704, detecting a congestion event associated with a first traffic flow. In some embodiments, an RLC layer may detect the congestion event based on inter-layer signaling. For example, the RLC layer may detect the congestion event based on a congestion indication received from upper or lower layers of a device implementing the RLC layer. In some embodiments, the RLC layer may detect the congestion event based on inter-device signaling. For example, the RLC layer may receive RLC feedback or an RLC status report from another device.

The operation flow/algorithmic structure 700 may further include, at 708, generating an RLC PDU with a CE indication. The CE indication may be provided by one or more CE bits set to provide a CE-set indication to indicate the traffic flow is experiencing congestion, or it may be a CE-clear indication to indicate the traffic flow is not experiencing congestion. In other embodiments, the CE indication may be set to provide an indication of a level of congestion being experienced by the traffic flow.

In some embodiments, the RLC PDU may be a RLC control PDU, which may be prioritized for transmission ahead of other PDUs in a queue. The RLC control PDU may include no sequence number and one octet; an 18-bit sequence number; a 12-bit sequence number; a 6-bit sequence number in a first of two octets of the RLC control PDU; a 6-bit sequence number in a second of two octets of the RLC control PDU; or a six-bit sequence number distributed in first and second octets of two octets of the RLC control PDU.

In some embodiments, the RLC PDU may be an RLC data PDU. The RLC data PDU may include a complete RLC SDU or may include an RLC SDU segment having a lowest segment index number of a plurality of RLC SDU segments (thus, the RLC data PDU may not include an SO field). The RLC data PDU may include an AMD format or a UMD format. In some embodiments, if the RLC data PDU has an AMD format it may include a 18-bit sequence number and one or more bits of an octet having a lowest octet index number of a plurality of octets of the RLC data PDU to carry the CE indication. In some embodiments, if the RLC data PDU has an AMD format it may include a 12-bit sequence number and one or more bits of an octet having an octet index number greater than two to carry the CE indication.

The operation flow/algorithmic structure 700 may further include, at 712, transmitting the RLC PDU. The RLC PDU may be transmitted in the direction of the traffic flow associated with the congestion event or in an opposite direction.

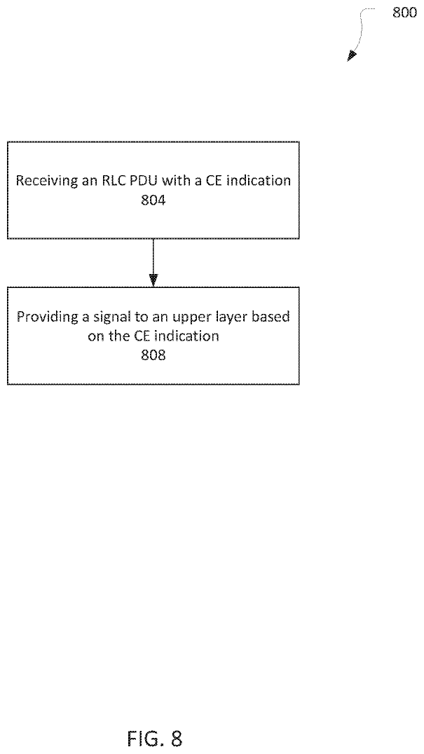

FIG. 8 is an operation flow/algorithmic structure 800 in accordance with some embodiments. The operation flow/algorithmic structure 800 may be implemented by an RLC receiver included in a UE (for example, UE 104 or UE 900), or a network node (for example, BS 108, IAB node 212, IAB donor 204, or network node 1000) or components therein, for example, processing circuitry 904 or 1004.

The operation flow/algorithmic structure 700 may include, at 704, receiving an RLC PDU with a CE indication. The RLC PDU may be associated with a traffic flow from or to another device. The RLC may have a CE indication corresponding to the traffic flow. The CE indication may be a CE-set indication to indicate the traffic flow is experiencing congestion or a CE-clear indication to indicate the traffic flow is not experiencing congestion. The RLC PDU may have a format similar to that described above with respect to FIG. 7 or elsewhere herein.

The operation flow/algorithmic structure 700 may further include, at 708, providing a signal to an upper layer of a device implementing the RLC transmitter. The signal may be an inter-layer signal such as a primitive, event, or message. The signal may provide a congestion indication associated with the traffic flow.

In some embodiments, the RLC transmitter may also provide an inter-device signal to provide a CE indication to an RLC layer of another device based on the CE indication of the RLC PDU.

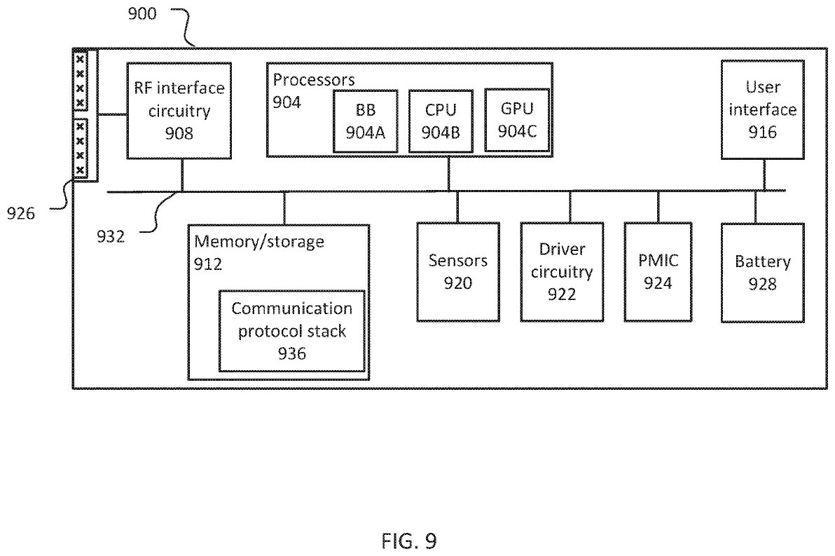

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein. The memory/storage 912 include any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within, or connected to, the UE 900. For example, the driver circuitry 912 may include circuitry to facilitate coupling of a UICC (for example, UICC 98) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

In some embodiments, the PMIC 924 may control, or otherwise be part of, various power saving mechanisms of the UE 900 including DRX as discussed herein.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

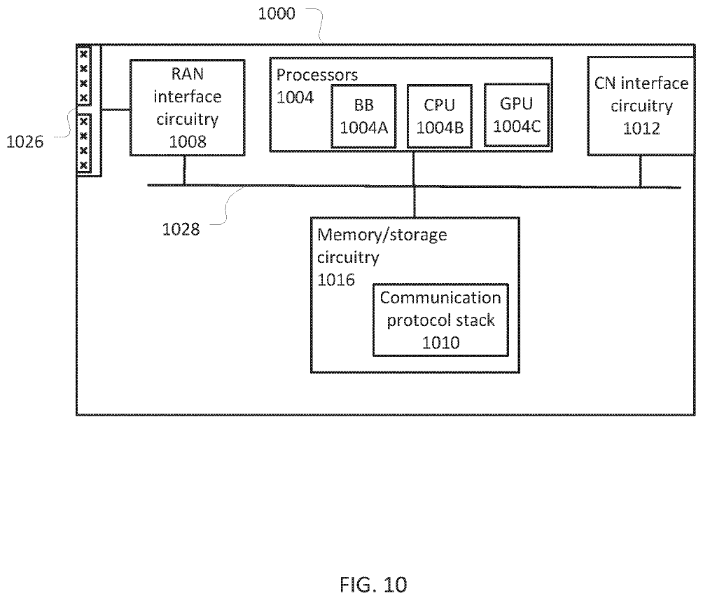

FIG. 10 illustrates a network node 1000 in accordance with some embodiments. The network node 1000 may be similar to and substantially interchangeable with base station 108, a device implementing one of the network hops 124, a network-controlled repeater, or a server in a core network or external data network.

The network node 1000 may include processors 1004, RF interface circuitry 1008 (if implemented as an access node), core network (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The CN interface circuitry 1012 may provide connectivity to a core network, for example, a 5th Generation Core network (5GC) using a 5GC-compatible network interface protocol such as carrier Ethernet protocols, or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes a method of operating a first device, the method comprising: detecting a congestion event associated with a traffic flow; generating a radio link control (RLC) protocol data unit (PDU) with a congestion experienced (CE) indication; and transmitting the RLC PDU to a second device.

Example 2 includes the method of example 1 or some other example herein, wherein the RLC PDU is an RLC control PDU and the method further comprises: placing the RLC control PDU in a queue, wherein the RLC control PDU is prioritized for transmission ahead of other PDUs of the queue.

Example 3 includes the method of example 1 or some other example herein, wherein the RLC PDU is an RLC control PDU that comprises: no sequence number and one octet; an 18-bit sequence number; a 12-bit sequence number; a 6-bit sequence number in a first of two octets of the RLC control PDU; a 6-bit sequence number in a second of two octets of the RLC control PDU; or a six-bit sequence number distributed in first and second octets of two octets of the RLC control PDU.

Example 4 includes a method of example 1 or some other example herein, wherein the RLC PDU is an RLC control PDU that comprises a field to indicate the RLC control PDU has no sequence number, an 18-bit sequence number, a 12-bit sequence number, or a 6-bit sequence number.

Example 5 includes a method of example 1 or some other example herein, wherein the RLC PDU is an RLC data PDU having a data field that includes a complete RLC service data unit (SDU) or includes an RLC service data unit (SDU) segment having a lowest segment index number of a plurality of RLC SDU segments.

Example 6 includes a method of example 5 or some other example herein, wherein the RLC data PDU comprises: an acknowledgment mode data (AMD) format; a 18-bit sequence number; and one or more bits of an octet having a lowest octet index number of a plurality of octets of the RLC data PDU to carry the CE indication.

Example 7 includes a method of example 5 or some other example herein, wherein the RLC data PDU comprises: an acknowledgment mode data (AMD) format; a 12-bit sequence number; and one or more bits of an octet having an octet index number greater than two to carry the CE indication.

Example 8 includes a method of example 1 or some other example herein, wherein the RLC data PDU comprises: an unacknowledged mode data (UMD) format; a complete RLC SDU or a 12-bit sequence number; and one or more bits of an octet having a lowest octet index number of a plurality of octets of the RLC data PDU to carry the CE indication.

Example 9 includes the method of example 1 or some other example herein, wherein the RLC data PDU comprises: an unacknowledged mode data (UMD) format; a 6-bit sequence number; and one or more bits of an octet having an octet index number of two or greater to carry the CE indication.

Example 10 includes the method of example 1 or some other example herein, further comprising: detecting the congestion event by an RLC layer based on: RLC feedback, an RLC status report, or a congestion indication provided by another layer.

Example 11 includes the method of example 1 or some other example herein, wherein the RLC PDU is a first RLC PDU, the congestion event is a first congestion event associated with the first RLC PDU, and the method further comprises: detecting a second congestion event associated with a second RLC PDU of the traffic flow; and generating a plurality of RLC PDUs with the CE indication based on detecting the first congestion event, the plurality of RLC PDUs including the first RLC PDU and all RLC PDUs generated before the second RLC PDU.

Example 12 includes a method of operating a first device, the method comprising: receiving, at a radio link control (RLC) layer, an RLC protocol data unit (PDU) with a congestion experienced (CE) indication, the RLC PDU associated with a traffic flow from or to a second device; providing a signal to an upper layer of the first device based on the CE indication.

Example 13 includes the method of example 12 or some other example herein, wherein the CE indication is a CE-set indication to indicate the traffic flow is experiencing congestion or is a CE-clear indication to indicate the traffic flow is not experiencing congestion.

Example 14 includes the method of example 12 or some other example herein, further comprising: determining the CE indication has changed from a previous CE indication; and providing the signal to an upper layer of the first device based on said determining the CE indication has changed from the previous CE indication.

Example 15 includes the method of example 12 or some other example herein, wherein the CE indication is a first CE indication that is associated with a first sequence number of the traffic flow and the method further comprises: receiving a second CE indication that is associated with a second sequence number; determining the first CE indication applies to traffic flow having sequence numbers between the first and second sequence numbers.

Example 16 includes the method of example 15 or some other example herein, wherein the traffic flow has a plurality of PDUs with sequence numbers between the first and second sequence numbers and the method further comprises: providing signals to the upper layer for individual PDUs of the plurality of PDUs.

Example 17 includes the method of example 12 or some other example herein, wherein the first device is a base station distributed unit, the second device is a user equipment or integrated access and backhaul-mobile termination, and the method further comprises: generating, by the upper layer, a packet that includes the CE indication; and transmitting the packet to a corresponding upper layer of a base station centralized unit.

Example 18 includes the method of example 17 or some other example herein, wherein the upper layer is an Internet protocol (IP) layer.

Example 19 includes the method of example 12 or some other example herein, wherein the signal is a first signal, the first device is an integrated access and backhaul (IAB)-mobile termination (MT) or an IAB-distributed unit (DU) and the method further comprises: providing a second signal to an RLC layer of a third device based on the CE indication.

Example 20 includes the method of example 19 or some other example herein, wherein the third device is an IAB distributed unit or another IAB-MT.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
detecting a congestion event associated with a traffic flow;
generating a radio link control (RLC) protocol data unit (PDU) with a congestion experienced (CE) indication; and
outputting the RLC PDU for transmission to a device.

22. The method of claim 21, wherein the RLC PDU is an RLC control PDU and the method further comprises:
placing the RLC control PDU in a queue, wherein the RLC control PDU is prioritized for transmission ahead of other PDUs of the queue.

23. The method of claim 21, wherein the RLC PDU is an RLC control PDU that comprises: no sequence number and one octet; an 18-bit sequence number; a 12-bit sequence number; a 6-bit sequence number in a first of two octets of the RLC control PDU; a 6-bit sequence number in a second of two octets of the RLC control PDU; or a six-bit sequence number distributed in first and second octets of two octets of the RLC control PDU.

24. The method of claim 21, wherein the RLC PDU is an RLC control PDU that comprises a field to indicate the RLC control PDU has no sequence number, an 18-bit sequence number, a 12-bit sequence number, or a 6-bit sequence number.

25. The method of claim 21, wherein the RLC PDU is an RLC data PDU having a data field that includes a complete RLC service data unit (SDU) or includes an RLC service data unit (SDU) segment having a lowest segment index number of a plurality of RLC SDU segments.

26. The method of claim 25, wherein the RLC data PDU comprises: an acknowledgment mode data (AMD) format; a 18-bit sequence number; and one or more bits of an octet having a lowest octet index number of a plurality of octets of the RLC data PDU to carry the CE indication.

27. The method of claim 25, wherein the RLC data PDU comprises: an acknowledgment mode data (AMD) format; a 12-bit sequence number; and one or more bits of an octet having an octet index number greater than two to carry the CE indication.

28. The method of claim 21, wherein the RLC data PDU comprises: an unacknowledged mode data (UMD) format; a complete RLC SDU or a 12-bit sequence number; and one or more bits of an octet having a lowest octet index number of a plurality of octets of the RLC data PDU to carry the CE indication.

29. The method of claim 21, wherein the RLC data PDU comprises: an unacknowledged mode data (UMD) format; a 6-bit sequence number; and one or more bits of an octet having an octet index number of two or greater to carry the CE indication.

30. The method of claim 21, further comprising:
detecting the congestion event by an RLC layer based on RLC feedback or an RLC status report.

31. The method of claim 21, further comprising:
detecting the congestion event by an RLC layer based on a congestion indication provided by another layer.

32. The method of claim 21, wherein the RLC PDU is a first RLC PDU, the congestion event is a first congestion event associated with the first RLC PDU, and the method further comprises:
detecting a second congestion event associated with a second RLC PDU of the traffic flow; and
generating a plurality of RLC PDUs with the CE indication based on detecting the first congestion event, the plurality of RLC PDUs including the first RLC PDU and all RLC PDUs generated before the second RLC PDU.

33. One or more non-transitory, computer-readable media having instructions that, when executed, cause processor circuitry to:
receive, at a radio link control (RLC) layer, an RLC protocol data unit (PDU) with a congestion experienced (CE) indication, the RLC PDU associated with a traffic flow from or to a device; and
provide a signal to an upper layer based on the CE indication.

34. The one or more non-transitory, computer-readable media of claim 33, wherein the CE indication is a CE-set indication to indicate the traffic flow is experiencing congestion or is a CE-clear indication to indicate the traffic flow is not experiencing congestion.

35. The one or more non-transitory, computer-readable media of claim 33, wherein the instructions, when executed, further cause the processor circuitry to:
determine the CE indication has changed from a previous CE indication; and
provide the signal to an upper layer based on said determination the CE indication has changed from the previous CE indication.

36. The one or more non-transitory, computer-readable media of claim 33, wherein the CE indication is a first CE indication that is associated with a first sequence number of the traffic flow and the instructions, when executed, further cause the processor circuitry to:
receive a second CE indication that is associated with a second sequence number; and
determine the first CE indication applies to traffic flow having sequence numbers between the first and second sequence numbers.

37. The one or more non-transitory, computer-readable media of claim 36, wherein the traffic flow has a plurality of PDUs with sequence numbers between the first and second sequence numbers and the instructions, when executed, further cause the processor circuitry to:
provide signals to the upper layer for individual PDUs of the plurality of PDUs.

38. The one or more non-transitory, computer-readable media of claim 33, wherein the processor circuitry is to be implemented in a base station distributed unit, the device is a user equipment or integrated access and backhaul-mobile termination, and the instructions, when executed, further causes the processor circuitry to:
generate, by the upper layer, a packet that includes the CE indication; and
transmit the packet to a corresponding upper layer of a base station centralized unit.

39. The one or more non-transitory, computer-readable media of claim 38, wherein the upper layer is an Internet protocol (IP) layer.

40. The one or more non-transitory, computer-readable media of claim 33, wherein the signal is a first signal, the device is a first device that is an integrated access and backhaul (IAB)-mobile termination (MT) or an IAB-distributed unit (DU) and the instructions, when executed, further cause the processor circuitry to:
provide a second signal to an RLC layer of a second device based on the CE indication, wherein the second device is an IAB distributed unit or another IAB-MT.
